(19) United States
(12) Patent Application Publication
(10) Pub. No.: US 2015/0222662 A1
(43) Pub. Date: Aug. 6, 2015

(54) Remote Data Access Permission

(71) Applicants: Muzhar Khokhar, Shrewsbury, MA (US); Joseph Bet-Eivazi, Methuen, MA (US)

(72) Inventors: Muzhar Khokhar, Shrewsbury, MA (US); Joseph Bet-Eivazi, Methuen, MA (US)

(21) Appl. No.: 14/170,624

(22) Filed: Feb. 2, 2014

(51) Int. Cl. H04L 29/06

(52) U.S. Cl. CPC H04L 63/164; H04L 63/061

(57) ABSTRACT

One embodiment of a target device needing to request permission from a source device to access data previously transmitted from the source device to the target device. The source device then requesting permission from the user to allow or deny the target device access to the data. The source device then allowing or denying access to the data, in accordance to the decision of the user.

### CROSS-REFERENCE TO RELATED APPLICATIONS

This application claims the benefit of non-provisional patent application Ser. No. 14/157,483, filed 2014 Jan. 16 by the present inventors.

### BACKGROUND-PRIOR ART

Current methods for communicating data over a network do not allow the sender of a data, or source device, the ability to dynamically and remotely prevent a receiver of the data, or target device, from accessing the data. Once the data is transmitted to the target device, the target device can then access the data at will. The source device has no control in remotely preventing the target device from accessing the data. This can be a major dilemma for the source device should it not want the data accessible to the target device once the data is transmitted.

In the Multi Layered Secure Data Storage and Transfer Process with pending patent application Ser. No. 14/157,483 (referred to as the other patent), the communicated data is stored on the target device, but is inaccessible. In order for the target device to access the data, it must interact with the source device in order to access the data. This approach works well for securing the data but there are no means for the source device to dynamically prevent the target device from being able to access the data.

### SUMMARY

In accordance with one embodiment, the Remote Data Access Permission is a method wherein communicated data from a source device to a target device is completely secured unless permission to access the data is granted from the source device. This embodiment allows the user of the source device to dynamically and remotely grant or deny permission to the target device in order to access a data the source device has previously communicated which would otherwise be inaccessible.

### Advantages

Accordingly several advantages of one or more aspects are as follows: a secure data communicated over a network from a source device to a target remains inaccessible to the target device unless permission is granted from the source device; the source device is alerted to all requests, for accessing the data, from the target device which; the source device has the ability to allow or deny the target device access to the data dynamically and remotely.

### DRAWINGS—FIGURES

FIG. 1A illustrates an example flow diagram of an accepted data access request of a target device incorporated into the old workflow.

FIG. 1B illustrates an example flow diagram of the data access request shown in FIG. 1A being allowed by a user.

FIG. 2A illustrates an example flow diagram of a denied data access request of a target device incorporated into the old workflow.

FIG. 2B illustrates an example flow diagram of the data access request shown in FIG. 2A being denied by a user.

### DRAWINGS—REFERENCE NUMERALS

110 source device

112 server

114 target device

116 private key of source device 110

118 public key of source device 110

120 private key of target device 114

122 public key of target device 114

124 data target device 114 requests for access encoded with a key

126 key needed to decode encoding 124 encoded with public key 118 on server 112

128 decision processor

130 positive decision

132 key needed to decode encoding 124 encoded with public key 118 on source device 110

134 public key of target device 114

136 encoding 132 decoded with private key 116, revealing key necessary to decode 124

138 resulting key from 136 encoded with public key 134 on source device 110

140 encoding 138 on server 112

142 encoding 140 on target device 114

144 encoding 142 decoded with private key 120, revealing key

146 encoding 124 decoded with the resulting key from decoding 144, revealing the data

148 request from target device 114 to server 112 for encoding 138

150 request from server 112 to source device 110 for encoding 138

152 request from source device 110 to server 112 for encoding 126

154 response from server 112 to source device 110 with encoding 126

156 request from source device 110 to server 112 for public key 122

158 response from server 112 to source device 110 with public key 122

160 response from source device 110 to server 112 with encoding 138

162 response from server 112 to target device 114 with encoding 140

210 user of source device 110

214 permission request from source device 110 to user 210

216 positive response from user 210 to source device 110

310 negative decision

312 negative response from source device 110 to server 112

314 negative response from server 112 to target device 114

410 negative response from user 210 to source device 110

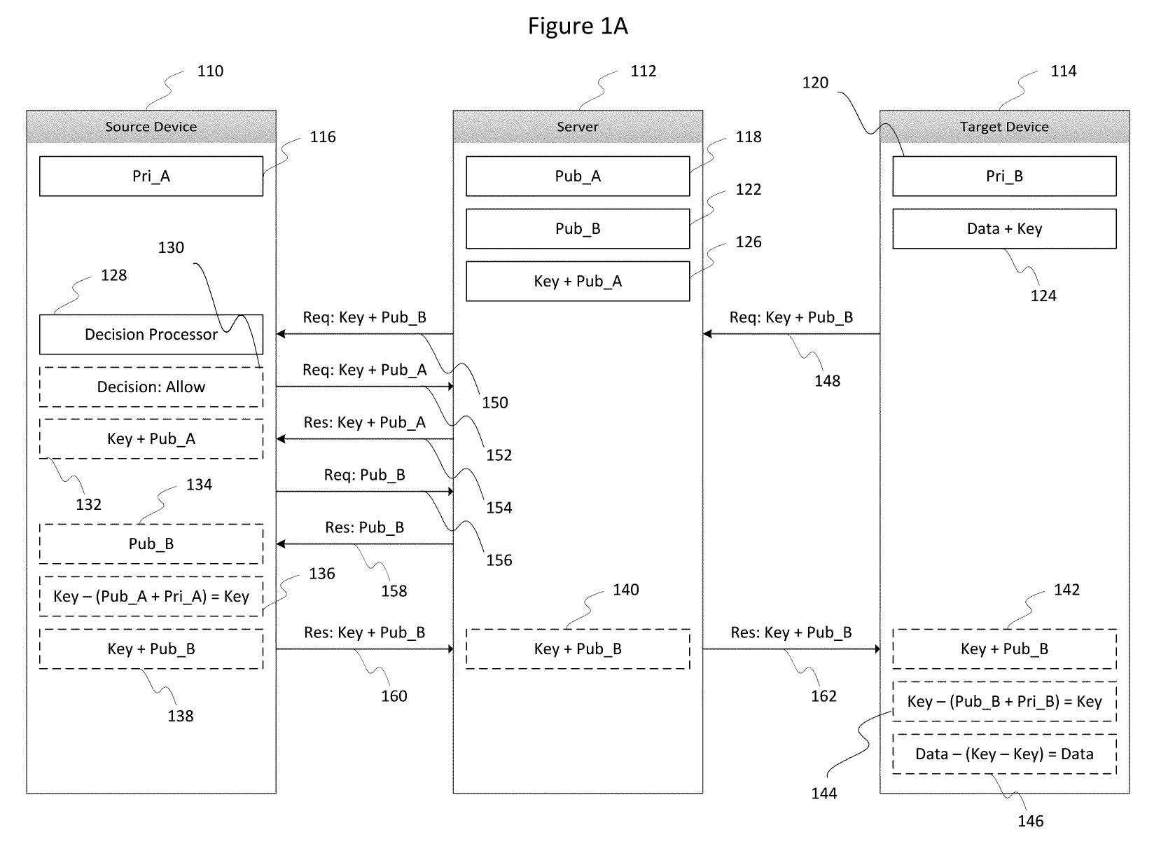

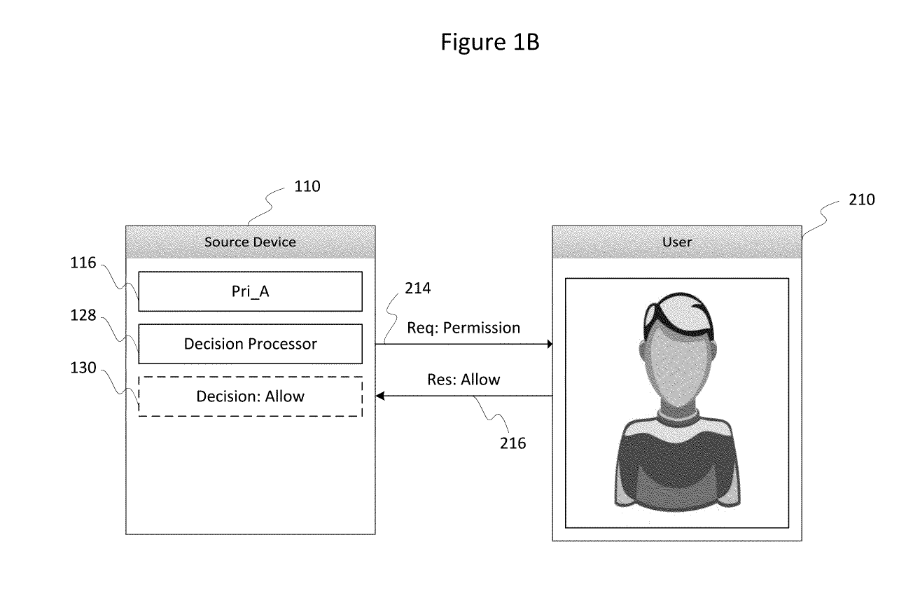

### Detailed Description—FIG. 1A—First Embodiment

One embodiment of an accepted data access request of a target device incorporated into, the old workflow is shown in FIG. 1A. There are two new components added to source device 110 in this improvement patent. First is decision processor 128 which received request 150, processes the request for a decision, evaluates the decision which in this figure is decision 130, and act on the decision appropriately. The processing of the request is shown in the following description for FIG. 1B. Evaluated decision can be either the positive decision 130 or a negative decision 310. Since the decision is the positive decision 130, the workflow for making the encrypted data accessible for the target device 114 is carried out in accordance to the other patent.

### Detailed Description—FIG. 1B—First Embodiment

One embodiment of a data access request being allowed by a user 210 is shown in FIG. 1B. Decision processor 128 transmits request 214 to user 210 for a positive or negative decision. User 210 has the option to approve the request 214, allowing the target device to access the data, or decline request 214, preventing the target device from accessing the data. The user 210 approves of request 214 by transmitting positive response 216 to the source device 110 at 130. The decision processor 128 takes response 130 as input and processes the decision to decide whether it is positive or negative and takes action accordingly. The action for a positive decision 130 is described in the previous description 1A.

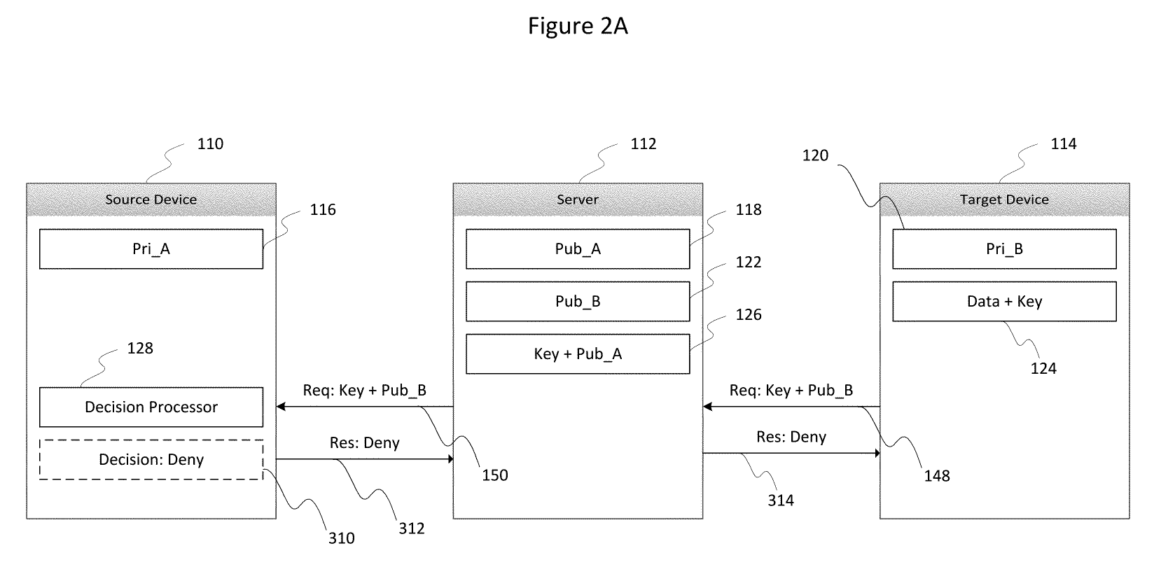

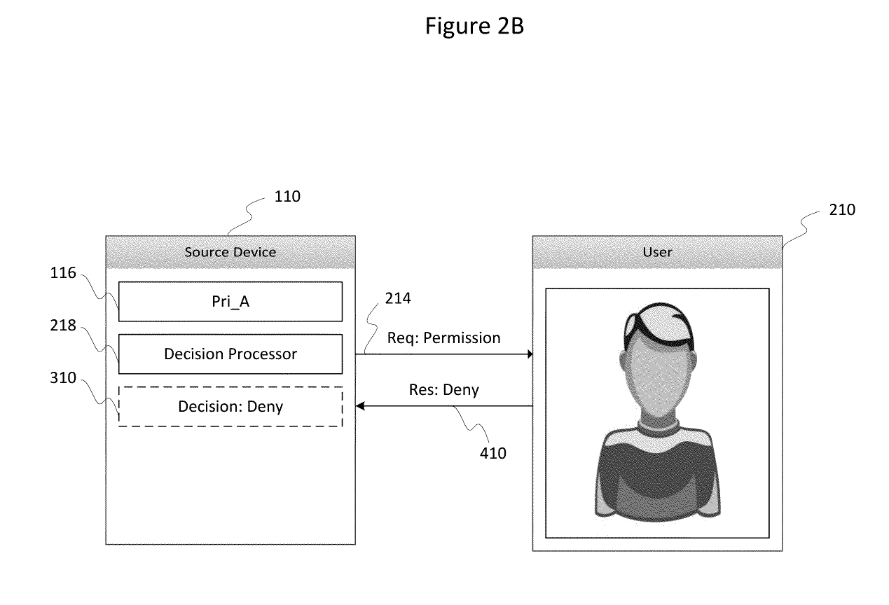

### Detailed Description—FIG. 2A—First Embodiment

One embodiment of a declined data access request of a target device incorporated into the old workflow is shown in FIG. 2A. This figure is similar to that of FIG. 1A. The decision processor 128 in this case receives a negative decision 310 which terminates the remaining workflow of FIG. 1A which would allow the target device 114 access to the encrypted data. Instead, a negative response 312 is sent to the server 112 which is then relayed to the target device 114 through response 314.

### Detailed Description—FIG. 2B—First Embodiment

One embodiment of a data access request being declined by a user 210 is shown in FIG. 2B. Decision processor 128 transmits request 214 to user 210 for a positive or negative decision. User 210 has the option to approve the request 214, allowing the target device to access the data, or decline request 214, preventing the target device from accessing the data. The user 210 declines request 214 by transmitting negative response 410 to the source device 110 at 310. The decision processor 128 takes decision 310 as input and processes the decision to decide whether it is positive or negative and takes action accordingly. The action for a negative decision 310 is described in the previous description 2k

### Operation—FIG. 1A

The manner to allow a target device to access an encoded data previously transmitted to it is shown in FIG. 1. Target device 114 first requests encoding 138 from server 112 by transmitting request 148. Server 112 receives request 148 and transmits request 150 to source device 110. Source device 110 receives request 150 and a decision processor 128 processes whether it should allow or deny request 150. A positive decision is received at 130 and processed by the decision processor 128 to identify whether it is positive or negative. Decision processor 128 identifies positive decision 130, there for, source device 110 responds by transmitting request 152 to server 112 for encoding 126. Server 112 receives request 152 and responds with response 154. Source device 110 receives response 154 at 132. Source device 110 then transmits request 156 to server 112 for public key 122. Server 112 responds to request 156 with response 158. Source device 110 receives response 158 at location 134. Encoding 132 is decoded at 136 using private key 116, resulting in a key. Source device 110 encodes the key result of decoding 136 with public key 134. Source device 110 transmits encoding 138 to server 112 through response 160, in accordance to the original request 150. Server 112 receives response 160 at 140. Server 112 transmits encoding 140 to target device 114 through response 162, in accordance to request 148. Target device 114 receives transmission 162 at 142. Target device 114 decodes encoding 142 with private key 120 at decoding 144, resulting in the key. Target device 114 uses the resulting key, from decoding 144, to decode encoding 124 at decoding 146, resulting in the accessible data.

### Operation—FIG. 1B

The manner for a user 210 to submit a positive response is shown in FIG. 1B. The decision processor 128 transmits request 214 to user 210. The user 210 is notified of request 214 and is given two options, to allow or to deny. The user 210 selects to allow and response 216 is transmitted back to source device 110 and is received at 130.

### Operation—FIG. 2A

The manner to deny a target device from accessing an encoded data previously transmitted to it is shown in FIG. 2A. Target device 114 first requests encoding 138 from server 112 by transmitting request 148. Server 112 receives request 148 and transmits request 150 to source device 110. Source device 110 receives request 150 and a decision processor 128 processes whether it should allow or deny request 150. A negative decision is received at 310 and source device 110 responds by transmitting response 312 to server 112. Server 112 then transmits response 314 to target device 114 which ends the process, resulting in target device 114 not being able to access the encoded data.

### Operation—FIG. 2B

The manner for a user 210 to submit a negative response is shown in FIG. 2B. The decision processor 128 transmits request 214 to user 210. The user 210 is notified of request 214 and is given two options, to allow or to deny. The user 210 selects to deny and response 410 is transmitted back to source device 110 and is received at 310.

### Conclusion, Ramifications, and Scope

Thus the reader will see that at least one embodiment of the system allows for secure data communicated from a source device to a target device to remain inaccessible for the target device unless access is approved by the source device.

While my above description contains many specificities, these should not be construed as limitations on the scope, but rather as an exemplification of one embodiment thereof. Many other variations are possible. For example, other means may be used for processing the positive or negative decision of the user instead of a decision processor as shown in this embodiment. Also, alternative actions may take place in order to end the workflow of the other patent when the user denies the target device access to the data, such as simply terminating the work flow without notifying the target device of the denied access.

Accordingly, the scope should be determined not by the embodiment illustrated, but by the appended claims and their legal equivalents.

We claim:

1. A method for allowing a source device the ability to dynamically and remotely grant a remote target device access to an otherwise inaccessible data the source device has previously communicated to the target device, comprising:
A method for securely communicating the presently inaccessible data from the source device to the target device;
A method for the target device to notify the user when it is requesting access to the inaccessible data;
A method for the user to grant the target device access to the inaccessible data.

2. The method of claim 1, wherein the method for securely communicating the presently inaccessible data from the source device to the target device is in accordance to the other patent.

3. The method of claim 1, wherein the method for the target device to notify the user when it is requesting access to the inaccessible data consists of:
Transmitting a request to a server;
The server transmitting the request to the source device;
The source device transmitting the request to the user.

4. The method of claim 1, wherein the method for the user to grant the target device access to the inaccessible data consists of:
The user communicating a positive response to the source device;
The method for the source device to allow the target device access to the data is carried out in accordance to the method of the other patent.

5. A method for allowing a source device the ability to dynamically and remotely deny a remote target device access to an inaccessible data the source device has previously communicated to the target device, comprising:
A method for securely communicating the presently inaccessible data from the source device to the target device;
A method for the target device to notify the user when it is requesting access to the inaccessible data;
A method for the user to deny the target device access to the inaccessible data.

6. The method of claim 5, wherein the method for securely communicating the presently inaccessible data from the source device to the target device is in accordance to the other patent.

7. The method of claim 5, wherein the method for the target device to notify the user when it is requesting access to the inaccessible data consists of:
Transmitting a request to a server;
The server transmitting the request to the source device;
The source device transmitting the request to the user.

8. The method of claim 5, wherein the method for the user to deny the target device access to the inaccessible data consists of:
The user communicating a negative response to the source device;
The method for the source device to allow the target device access to the data in accordance to the method of the other patent is ended.
